(19) United States
(12) Patent Application Publication
(10) Pub. No.: US 2007/0251586 A1
(43) Pub. Date: Nov. 1, 2007

(54) Electro-pneumatic control valve with microvalve pilot

(76) Inventors: Edward Nelson Fuller, Manchester, MI (US); Mark Luckevich, Ann Arbor, MI (US)

Correspondence Address: MACMILLAN SOBANSKI & TODD, LLC, ONE MARITIME PLAZA FIFTH FLOOR, 720 WATER STREET, TOLEDO, OH, 43604-1619, US

(21) Appl. No.: 11/731,769

(22) Filed: Mar. 30, 2007

Related U.S. Application Data
(63) Continuation-in-part of application No. 11/437,022, filed on May 18, 2006, now Pat. No. 7,210,502.
Application No. 11/437,022 is a continuation of application No. PCT/US04/39517, filed on Nov. 24, 2004.
(60) Provisional application No. 60/559,355, filed on Apr. 2, 2004.
(60) Provisional application No. 60/525,224, filed on Nov. 24, 2003.

(51) Int. Cl. F15B 5/00

(52) U.S. Cl. 137/596.16

(57) ABSTRACT

The invention relates to a MEMS (Micro Electro Mechanical Systems) device in the form of a pressure control valve suitable for controlling the operation of a refrigeration compressor. The pressure control valve is responsive to a reference pressure controlled by a microvalve.

### CROSS-REFERENCE TO RELATED APPLICATIONS

This application is a Continuation-In-Part of U.S. patent application Ser. No. 11/437,022 (filed May 18, 2006), which was a Continuation of PCT/US04/395 17 (filed Nov. 24, 2004), which claims priority from both U.S. Provisional Application 60/559,355 (filed Apr. 2, 2004, expired) and U.S. Provisional Application 60/525,224 (filed Nov. 24, 2003, expired). The disclosures of all four of these applications are incorporated herein by reference.

### STATEMENT REGARDING FEDERALLY SPONSORED RESEARCH OR DEVELOPMENT

This invention was made with United States Government support under cooperative agreement number 70NANB2H10A03 awarded by the National Institute of Standards and Technology (NIST). The United States Government has certain rights in the invention.

### FIELD OF THE INVENTION

This invention relates to a device suitable for use to control a variable capacity refrigerant compressor, and more particularly to an electro-pneumatic control valve having a bellows for altering operation of the valve in response to changing differential pressure across the bellows, and a MEMS device in the form of a microvalve for selectively applying a force upon the bellows.

### BACKGROUND OF THE INVENTION

Variable capacity refrigerant compressors have been utilized in automotive air conditioning systems, with the compressor capacity being controlled by a control valve. In a typical implementation, the compressor includes one or more pistons coupled to a tiltable wobble plate or swash plate, and the control valve is controlled to adjust the pressure in a crankcase of the compressor to control the compressor capacity. In one common arrangement, for example, the compressor suction (inlet) pressure acts on a bellows to linearly position an armature in a valve passage that couples the crankcase to the compressor discharge (outlet) pressure. If the suction pressure decreases due to a reduction in the cooling load, for example, the bellows expands to open the passage, raising the crankcase pressure and decreasing the compressor capacity. When the suction pressure rises due to the decreased compressor capacity, the bellows retracts the armature to close the passage, and the compressor capacity is maintained at the reduced level. A bleed passage couples the crankcase to a suction passage so that the compressor capacity will increase if the valve passage remains closed.

MEMS (Micro Electro Mechanical Systems) is a class of systems that are physically small, having features with sizes in the micrometer range. These systems have both electrical and mechanical components. The term “micromachining” is commonly understood to mean the production of three-dimensional structures and moving parts of these very small micro electro-mechanical devices (“MEMS devices”). MEMS originally used modified integrated circuit (computer chip) fabrication techniques (such as chemical etching) and materials (such as silicon semiconductor material) to micromachine these very small mechanical devices. Today there are many more micromachining techniques and materials available. The term “microvalve” as used in this application means a valve having features with sizes in the micrometer range, and thus by definition is at least partially formed by micromachining. The term “microvalve device” as used in this application means a device that includes a microvalve, and that may include other components. It should be noted that if components other than a microvalve are included in the microvalve device, these other components may be micromachined components or standard sized (larger) components.

### BRIEF SUMMARY OF THE INVENTION

The present invention is directed to an improved electromechanical control valve that, in one application, selectively moves a valve disk to open and close a passage between discharge and crankcase chambers of a variable capacity refrigerant compressor for purposes of controlling the compressor capacity, and a MEMS device in the form of a microvalve for selectively supplying a fluid pressure to one side of a diaphragm such that a force exerted by the fluid pressure on the diaphragm acts through the diaphragm and thence directly or indirectly upon the valve disk to selectively influence operation of the control valve. In a preferred embodiment, the electromechanical control valve further includes a sealed bellows operatively connected to the valve disk, such that the force exerted by the fluid pressure on the diaphragm acts through the diaphragm and thence directly or indirectly upon the bellows and upon the valve disk such that both the fluid pressure controlled by the microvalve and operation of the bellows act to determine the position of the valve disk and control the operation of the control valve. The bellows preferably is a sealed metal bellows disposed between the diaphragm and the valve disk. The bellows preferably contains a vacuum. The bellows is exposed to the suction of the compressor, so that the length of the bellows changes in response to changes in the pressure of fluid drawn into the suction of the compressor. With the bellows containing a suitably sufficient vacuum, the bellows will act as an absolute pressure reference.

Various advantages and applications of this invention will become apparent to those skilled in the art from the following detailed description of the preferred embodiment, when read in light of the accompanying drawings.

### BRIEF DESCRIPTION OF THE DRAWINGS

FIG. 1 shows a cross-sectional view of a pneumatically operated compressor capacity control valve with a MEMS device in the form of a microvalve for selectively altering the differential pressure across a diaphragm of the capacity control valve; and

FIG. 2 is a view similar to FIG. 1, except showing an alternate embodiment of the invention.

FIG. 3 is a bottom plan view of a microvalve manifold of the embodiment of FIG. 2.

FIG. 4 a perspective view of the microvalve manifold of the embodiment of FIGS. 2 and 3.

### DETAILED DESCRIPTION OF THE INVENTION

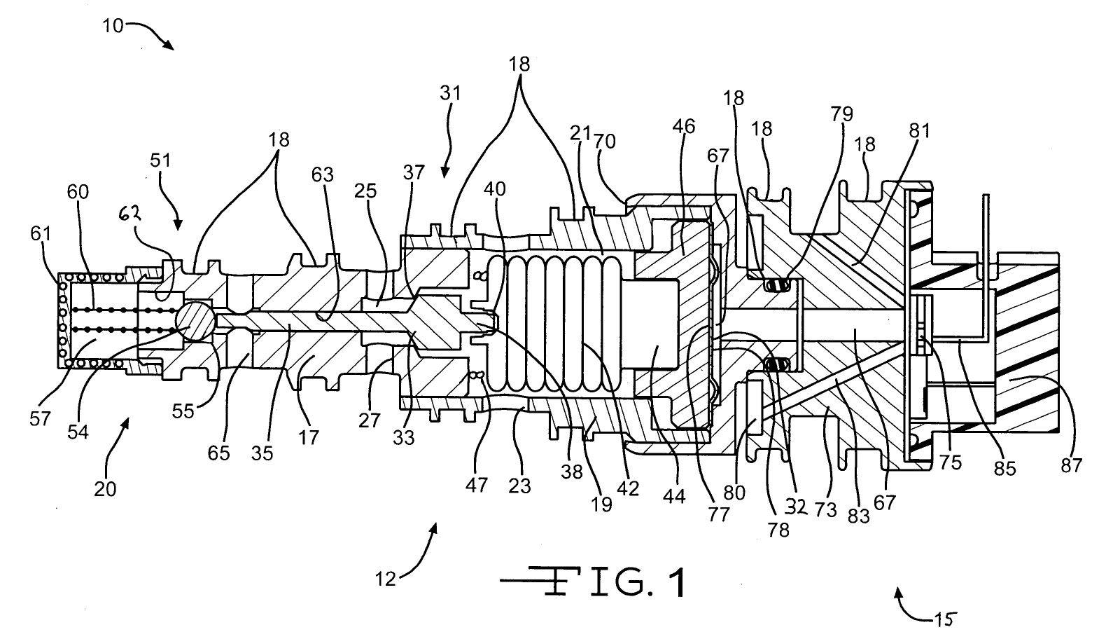

FIG. 1 illustrates a Variable set-point Control Valve (VCV) 10. The VCV 10 comprises a compressor displacement control portion 12 and a variable setpoint control portion 15. The compressor displacement control portion 12 controls the flow of refrigerant gas from a compressor (not shown) in and out of the VCV 10 while the variable setpoint control portion 15 controls the operation of the compressor displacement control portion 12. The displacement control portion 12 includes a valve body 17 is formed with many VCV functional elements, which will be described later. In the embodiment illustrated in FIG. 1, the valve body 17 is substantially cylindrical in shape as may be inferred from the cross-sectional view shown. 0-ring retaining grooves 18 are indicated on the exterior of the valve body 17 in two locations. When the VCV 10 is inserted into a control valve cavity of a compressor, it is assembled with o-ring seals (not shown) in the grooves 18 to allow different pressure sources to be communicated to different portions and ports of the VCV 10. A first end of the valve body 17 is fixed to a chamber body 19, leaving a second end 20 of the valve body exposed. In the illustrated embodiment, the chamber body 19 is a generally cylindrical hollow body, with a portion of the valve body 17 fitting into the interior of the chamber body 19 to close off one end of the chamber body 19. The chamber body 19 is fixed to the valve body 17 by any suitable means to form a suitably fluid-tight seal therebetween, such as by welding, swaging, press fitting, etc. Alternatively, suitable seals, such as o-rings, could be provided to form the fluid tight seal, or the chamber body 19 and the valve body 17 could be integrally formed.

The compressor displacement control portion 12 has a suction pressure chamber 21 defined therein, preferably as part of the cylindrical hollow interior of the chamber body 19. The suction pressure chamber 21 is connected via a port 23 to the inlet (suction) of the variable displacement compressor. A middle chamber 25 is also formed in the valve body 17, again preferably formed as a bore centered in the valve body 17, leading from the suction pressure chamber 21. A first middle port 27 is formed in the valve body 17 and communicates with the middle chamber 25 through a suction pressure valve 31. The first middle port 27 is in gas communication with the crankcase chamber of the compressor. The VCV 10 further comprises a pressure sensitive member, preferably in the form of a diaphragm 32, exposed to the suction pressure chamber 21. The suction pressure valve 31, comprising a suction valve disk 33 formed on a valve rod 35, and a suction valve seat 37 formed in the valve body 17, is provided to open and close a gas communication path between the suction pressure chamber 21 and the middle chamber 25.

The valve rod 35 includes a rounded boss 38 extending longitudinally out of the valve disk 33. The boss 38 is received in a recess 40 in a first end of a bellows 42, thereby supporting and guiding one end of the bellows 42. The bellows 42, in the illustrated embodiment of FIG. 1, is a sealed bellows, made of a suitable material, such as a suitable metal or plastic. The interior of the bellows 42 preferably contains a vacuum. The wall of the bellows 42 has a spring characteristic, and is elongated in a relaxed state. The bellows 42 is disposed in the suction pressure chamber 21, and thus is responsive to pressure in the suction pressure chamber 21, collapsing in length when the pressure in the suction pressure chamber 21 rises above the pressure inside the bellows 42, and expanding in length (back toward the elongated relaxed state of the bellows 42) when the pressure in the suction pressure chamber 21 falls. If the bellows 42 contains a suitably sufficient vacuum, and not a gas, the bellows 42 can act as an absolute pressure reference, in that the length of the bellows 42 will be related to the absolute pressure in the suction pressure chamber 21. The second end of the bellows 42 is formed as a cylindrical section 47. Optionally, the bellows 42 may have one or more supplemental compression springs (not shown) operatively connected to each of the first end and the second end of the bellows achieve a desired spring characteristic; suitably such supplemental compression springs are disposed inside of the bellows 42. Such supplemental springs may be made of any spring material suitable for this application, and need not be metal.

The suction valve disk 33 is urged against the suction valve seat 37 by a rigid member 46, which is in floating contact with the diaphragm 32. A bias spring 47, retained in middle chamber 25, urges the suction valve disk 33 off the suction valve seat 37, that is, urges the suction pressure valve 31 to open. It is also seen that the bias spring 47 opposes a movement of the diaphragm 32 towards the suction valve seat 37 and so acts as an equivalent pressure, a spring bias pressure, adding to the action of the suction pressure on the pressure receiving area of diaphragm 32. The VCV suction pressure valve 31 opens and closes a gas communication path between the suction (inlet) of the compressor and the crankcase of the compressor.

A discharge pressure valve 51 of VCV 10 is comprised of the valve body 17, a discharge valve ball 54, and a discharge valve seat 55 formed in valve body 17. The discharge valve ball 54 is positioned in a discharge pressure chamber 57 formed in the second end 20 of the valve body 17. The discharge pressure chamber 57 is formed as a stepped throughbore 62 that positions the discharge valve ball 54 in alignment with the discharge valve seat 55. A ball centering spring 60 may be used to further condition the nominal position of discharge valve ball 54. The spring 60 acts between the valve ball 54 and a particle filter cap 61 that sealably covers the second end 20 of the valve body 17. The particle filter cap 61 and the valve body 17 cooperate to define the discharge pressure chamber 57. When the VCV 10 is installed, typically by being inserted into a blind end of a control valve cavity formed in a head of the compressor, the various ports of the VCV 10 are connected to the appropriate fluid passageways of the compressor. For example, a discharge pressure path from the discharge area of the compressor is communicated to the blind end of the control valve cavity. Pressurized fluid (gas) from the discharge of the compressor is thereby communicated to the VCV discharge pressure chamber 57 through the particle filter cap 61. The o-ring grooves 18 on the valve body, and additional o-ring grooves 18 formed on the exterior of the chamber body 19 seal these components to wall of the control valve cavity, so as to guide fluid from the various ports of the VCV 10 to the appropriate fluid passageways of the compressor, which fluid passageways open into the control valve cavity.

The VCV 10 has a central bore 63 formed through the valve body 17. The central bore 63 extends from the VCV discharge pressure chamber 57 to the middle chamber 25, which are coaxially aligned. Like the first middle port 27, a second middle port 65 is formed in the valve body 17 and communicates with the central bore 63. The second middle port 65 is in fluid communication with the crankcase chamber of the compressor. When the discharge valve ball 54 is moved off the discharge valve seat 55, discharge pressure gas can flow through the bore 63 to the second middle port 65 and then to the crankcase chamber.

The valve rod 35, inserted in the central bore 63 partially links the actions of the suction pressure valve 31 and the discharge pressure valve 51 of the VCV 10. The valve rod 35 has a diameter slightly smaller than the central bore 63, so that the valve rod 35 freely slides in the central bore 63 yet substantially blocks gas communication between the middle chamber 25 and the discharge chamber 57. The length of the valve rod 35 is chosen so that it simultaneously touches the seated (fully closed) discharge valve ball 54 and the bellows 42 with the suction valve disk 33 in a fully open (fully unseated) position. This arrangement links the suction pressure valve 31 and the discharge pressure valve 51 in a partial open-close relationship. As the suction valve disk 33 moves in a valve-closing direction, the valve rod 35 pushes the discharge ball 54 in a valve-opening direction. As the discharge valve ball 54 moves in a valve closing direction, the valve rod 35 pushes the suction valve disk 33 in a valve-opening direction.

In the preferred embodiment of FIG. 1, the valve rod 35 is not attached to the discharge valve ball 54, though it is contemplated that such could be the case (if both the discharge valve ball 54 and the suction valve disk 33 are rigidly linked, then a full open-close relationship will exist). It is also contemplated that the suction valve disk 33 could be replaced by a ball that is not connected to the valve rod 35. The valve rod 35 operates to open either the discharge pressure valve 51 or the suction valve 31 of the VCV 10, but will only operate to close the integrally formed suction valve disk 33. The forces which act to close the discharge pressure valve 51 are the pressure of the discharge gas on an effective pressure receiving area of the discharge valve ball 54 and a small spring force imparted by the ball centering spring 60. The force that acts to close the suction pressure valve 31 derives from a movement of the pressure sensitive diaphragm 32 via the rigid member 46 and the bellows 42, and by expansion (lengthening) of the bellows 42.

Reference is made specifically now to the variable setpoint control portion 15 of the VCV 10. The variable setpoint control 15 comprises a closed reference chamber 67 bounded by the VCV diaphragm 32, the interior wall of a hollow valve end cap 70, the interior wall of a hollow microvalve manifold 73 and a microvalve 75. The diaphragm 32 is positioned and sealed against the chamber body 19, so as to seal the associated end of the suction pressure chamber 21, by the valve end cap 70. The valve end cap 70 is fixed to the chamber body 19. As illustrated FIG. 1, in a preferred embodiment, the valve end cap 70 has a skirt portion which surrounds an end portion of the chamber body 19. The skirt portion of the valve end cap 70 is fixed to the chamber body by any suitable means, such as welding, swaging, press fitting, etc., so as to hold the diaphragm 32 in place, and to hold the valve end cap 70 tightly against the circumferential periphery of the diaphragm 32 so that the diaphragm 32 seals against both the chamber body 19 and the valve end cap 70. The diaphragm 32 has a first side 77 sealed against the chamber body 19, with a suction pressure receiving area of the first side 77 exposed to suction pressure in the suction pressure chamber 21. The diaphragm 32 has a second side 78 sealed against the valve end cap 70, with a reference pressure receiving area exposed to the reference pressure in the reference chamber 67. The diaphragm 32 is arranged to seal the reference chamber 67 from direct gas communication with the suction pressure chamber 21, the discharge pressure chamber 57, the middle chamber 25 or the central bore 63.

The valve cap 70 has a reduced diameter section that extends partially into a mating recess in the microvalve manifold 73. The reduced diameter section of the valve cap 70 has an o-ring groove 18, in which is disposed an o-ring 79 . The o-ring 79 seals the boundary of the reference chamber 67 between the valve cap 70 and the microvalve manifold 73.

The microvalve manifold 73 has a first end that has two recesses formed in it. The first recess is the recess receiving the reduced diameter portion of the valve cap 70. The second recess 80 is an annular recess formed about and separated from the first recess. The first end of the microvalve manifold 73 is spaced apart from the valve cap 70 in the region defining the second recess 80, so that the second recess 80 communicates with the exterior of the VCV 10. A pair of o-ring grooves 18 are formed on the exterior of the microvalve manifold 73. Two pressure bleed passageways, a discharge bleed passageway 81 and a suction bleed passageway 83 are provided in the microvalve manifold 73. The discharge bleed passageway 81 provides communication between the exterior of the microvalve manifold 73 between the two o-ring grooves 18 and the microvalve 75, which is mounted on the axial end face of the second end of the microvalve manifold 73. The suction bleed passageway 83 provides communication between the second recess 80 and the microvalve 75. The bleed passageways provide a source of suction pressure gas and discharge pressure gas to the microvalve 75 from the appropriate passageways communicating with the control valve cavity.

The microvalve 75 is sealingly mounted on the microvalve manifold 73, to control fluid communication between the discharge bleed passageway 81 and the reference chamber 67, and to control fluid communication between the reference chamber 67 and the suction bleed passageway 83. The microvalve may be of any suitable type, including direct acting or pilot operated microvalves. While only one microvalve 75 is shown, more than one microvalve, acting in concert may be utilized. For example, one microvalve may be used to control fluid communication between the discharge bleed passageway 81 and the reference chamber 67, and another microvalve (which may be integrally formed with the other microvalve) may be used to control fluid communication between the reference chamber 67 and the suction bleed passageway 83. If pilot operated microvalves are used, additional microvalves in the form of one or two pilot microvalves for controlling the pilot operated microvalve(s) may be utilized. In a preferred embodiment, a thermally actuated three-way microvalve is used as the microvalve 75.

The microvalve 75 is mounted upon the microvalve manifold 73 in fluid communication with the reference chamber 67. The microvalve 75 is preferably mounted by a plurality of solder point connections. The points of solder connection between the microvalve manifold 73 and the microvalve 75 preferably includes the areas on the microvalve manifold 73 around the connection to the reference chamber 67, the discharge bleed passageway 81 and the suction bleed passageway 83, and do not include an area under an actuator (not shown) of the microvalve 75. However, it must be understood that the microvalve 75 may be mounted in any suitable manner, such as those disclosed in U.S. Pat. No. 6,581,640 entitled “Laminated Manifold for Microvalve”, the disclosures of which are hereby incorporated herein by reference, which describes a terminal block that is fixed to a manifold for a microvalve by any suitable means, such as a mechanical fastener (such as a rivet or a bolt, for example), by a suitable adhesive, or by soldering.

The microvalve 75 is provided with electrical connectors 85 to apply the electrical signal to actuate the microvalve 75. A connector cap 87 is fastened to the manifold 73, covering the microvalve 75. The electrical connectors 85 pass through the connector cap 87. Suitably, the electrical connectors 85 form a plug of the same type as used by a conventional electromagnetic clutch of a compressor, held in place by the connector cap 87, thereby allowing the electromagnetic clutch control wiring to be plugged into the electrical connectors 85. This will facilitate using a clutchless compressor controlled by the VCV 10 as a replacement for a conventional fixed displacement clutch compressor in a service situation, for example (or if an automobile manufacturer decides to change the type of compressor to be utilized in a vehicle).

In applications where a fixed displacement clutch compressor has previously been the norm, a significant cost and weight savings could be achieved by eliminating the clutch and using a clutchless, variable displacement compressor. As described above, one aspect of this invention entails mating the microvalve 75 to a conventional mechanical compressor control valve (preferably including the displacement control portion 12, the suction pressure valve 31 and the bellows 42) in a unique manner to provide an electronic means for controlling the operation of a clutchless compressor.

It is anticipated that the VCV 10 may suitably be connected to such a clutchless, variable displacement compressor. One controls the pumping capacity of the compressor by controlling the pressure inside the crankcase of the compressor. As the pressure inside the crankcase of the compressor rises, the capacity of the compressor is reduced, typically by tilting a wobble plate to reduce the stroke of the compressor as crankcase pressure increases. Indeed, with sufficient pressure in the crankcase, a suitable compressor could be made to de-stroke completely, that is to say, to reduce the pumping capacity to zero. In such a situation, the compressor is not much of a load on the prime mover (such as an automobile engine) driving the compressor. Such a compressor can thus be driven without a heavy, complicated electromagnetic clutch as has been typically used in automotive air conditioning systems in the past.

It is contemplated that the compressor can be controlled digitally (selectively compressing or not compressing) utilizing the existing clutch control signal to operate the microvalve 75. This arrangement will then allow a clutchless compressor to be used as a drop in replacement to conventional clutch compressors and provide for significant cost and weight reductions.

The bellows 42 is referenced to the suction pressure because the bellows 42 is disposed within the suction pressure chamber 21 (which is connected by a fluid passage through the port 23 to the suction of the compressor) The bellows 42 provides freeze protection for the refrigeration system by mechanically modulating the VCV 10. If suction pressure gets too low, the bellows 42 will expand to close the suction pressure valve 31 (shutting the middle chamber 25 off from the low pressure region in the suction pressure chamber, and moving the valve rod 35 sufficiently to lift the discharge valve ball 54 off the discharge valve seat 55, permitting relatively high pressure fluid from the discharge pressure chamber 57 to flow into the second middle port 65, and on into the compressor crankcase. Thus pressure in the compressor crankcase will rise, and de-stroke the compressor, limiting the cooling capacity of the air conditioning system, and thereby providing freeze protection. Note that the compressor will suitably be provided with a conventional arrangement, such as a fixed bleed port from crankcase to suction pressure, and a device for maintaining a minimum differential pressure when the compressor is de-stroked.

The diaphragm 32 mechanically interfaces with the displacement control portion 12 (that is, the suction pressure valve 31 and the discharge pressure valve 51) through the rigid member 46 and the bellows 42 so as to control the pressure in the compressor crankcase. If the pressure in the reference chamber 67 on the second side 78 of the diaphragm 32 is increased to be higher than the pressure in the suction pressure chamber 21 on the first side of the diaphragm 32, the diaphragm 32 is displaced from the illustrated rest position to an extended position (not shown), in which the diaphragm is displaced toward the displacement control portion 12. When the diaphragm 32 is moved to the extended position, the suction pressure valve 31 will be moved to the closed position thereof, and the discharge pressure valve 51 will be moved to the open position thereof, raising the pressure in the crankcase of the compressor, and de-stroking the compressor. Reducing the pressure in the reference chamber 67 will allow the diaphragm 32 to return from the extended position thereof to the illustrated position thereof. Displacement of the diaphragm 32 is thus achieved through the control of the pressure in the reference chamber 67. The pressure in the reference chamber 67 is controlled by the microvalve 75. If it is desired to raise pressure in the reference chamber 67, the microvalve 75 is operated to port relatively high pressure fluid from the discharge bleed passageway 81 to the reference chamber 67. If it is desired to lower pressure in the reference chamber 67, the microvalve 75 is operated to lower the pressure by sealing off the discharge bleed passageway 81, and opening the suction bleed passageway 83 to the reference chamber 67.

Suitably, the microvalve 75 is an electronically actuated device that uses the 12 volt clutch control signal. In the power off condition (in which a conventional air conditioning system would de-energize the electromagnetic clutch, allowing it to open spring pressure, unloading the conventional clutched compressor), the microvalve 75 ports discharge pressure to the reference chamber 67 so as the keep the components of the displacement control portion 12 positioned for the compressor de-stroked state. To up-stroke the compressor (that is, to increase the pumping capacity of the compressor), the 12 volts clutch control signal is turned on and applied to the microvalve 75 which in turn will change the pressure state in the reference chamber 67 and actuate the suction pressure valve 31 and discharge pressure valve 51 to decrease the crankcase pressure of the compressor. With the compressor up-stroked, the bellows 42 is also able to modulate the mechanical valve to maintain the freeze protection set point.

Suitably, one or more pressure sensors may be provided to sense pressure in the discharge bleed passageway 81 (compressor discharge pressure), the suction bleed passageway 83 (compressor suction pressure), and/or the reference chamber 67. In U.S. Pat. No. 6,622,500, a capacity control method for an air conditioning compressor is described that is based on the compressor suction and discharge pressures and a measure of the ambient temperature. A target suction pressure is selected based on the ambient temperature and the sensed discharge pressure, and the capacity of the compressor is adjusted as required to attain the target suction pressure. Pressure sensors sensing suction and discharge pressures, and the control pressure applied by the microvalve 75 to the reference chamber 67 would be helpful in performing this, or other methods of capacity control. These pressure sensors may be relatively inexpensively integrally formed with the microvalve 75 using micromachining techniques.

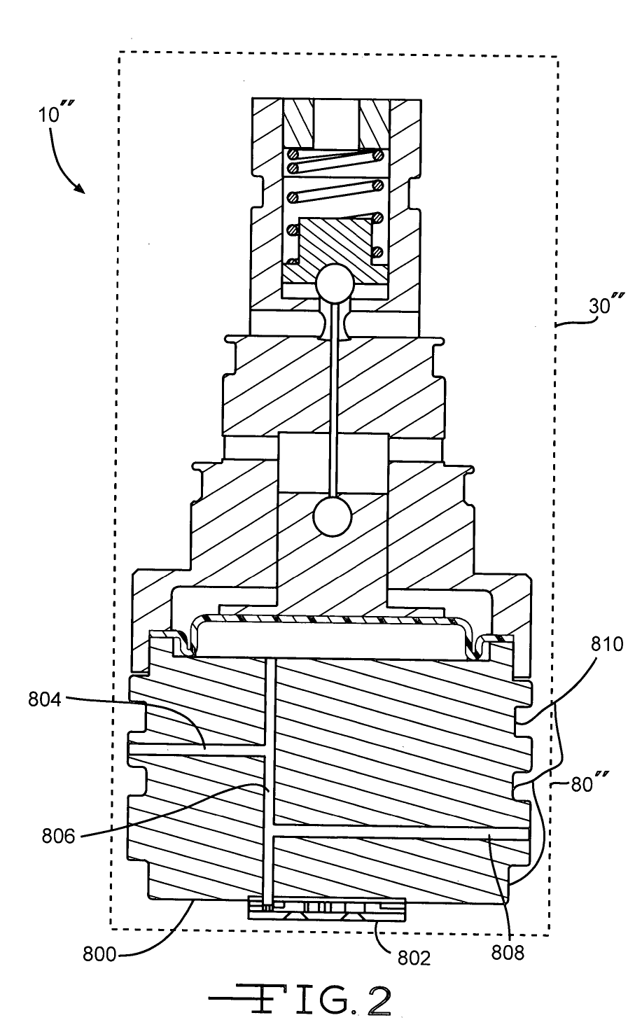

Referring now to FIG. 2, a microvalve operated control valve 10″ for a variable displacement compressor in accordance with another alternative embodiment of the present invention includes a compressor displacement control portion 30″ and a variable setpoint control portion 80″.

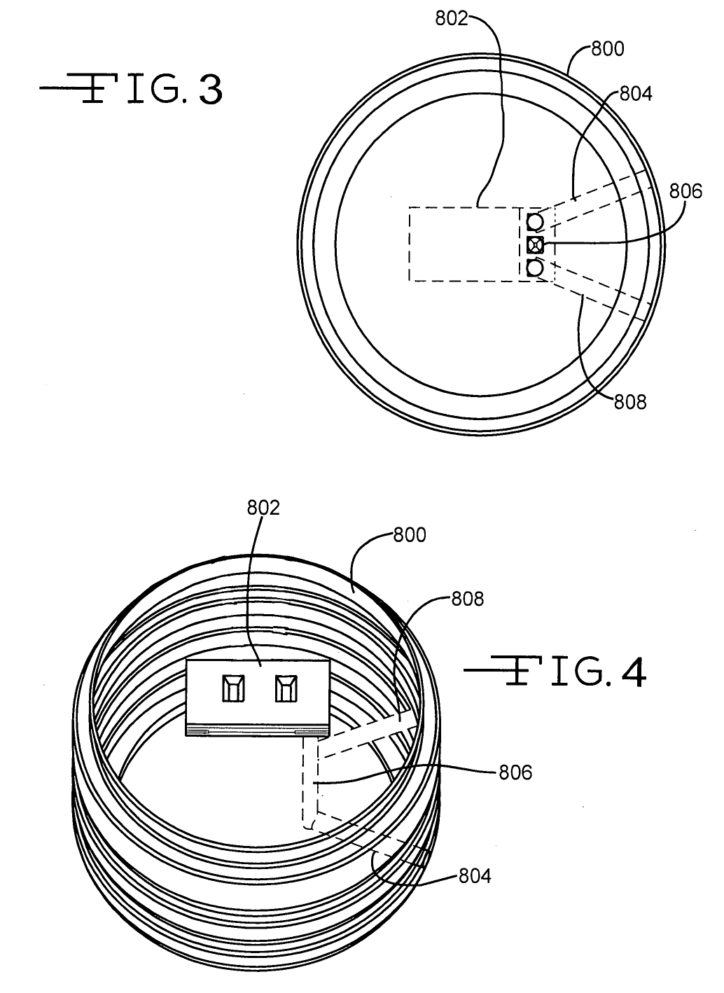

A plug 800 forms a microvalve manifold similar to the microvalve manifold 73 described above. As better seen in FIGS. 3 and 4, the plug 800 is generally cylindrical. The plug 800 includes three o-ring grooves 810 circumferentially formed about the surface of the plug 800 (similar to the o-ring grooves 18). An o-ring (not shown) disposed in each o-ring groove 810 will forms a seal between the plug 800 and the compressor valve cavity wall.

The discharge fluid passageway 804 provides fluid communication between the compressor discharge and a microvalve 802 mounted on the plug 800. A reference fluid passageway 806 allows fluid communication between the reference chamber 67 and the microvalve 802. A suction fluid passageway 808 allows fluid communication between the compressor suction and the microvalve 802. The microvalve 802 is operable to selectively allow fluid communication between the suction fluid passageway 808 and reference fluid passageway 806 and the discharge fluid passageway 804 and the reference fluid passageway 806.

It will be appreciated that the structure and operation of the control valve 10″ in FIG. 2 is similar to the VCV 10 described above, except that no bellows 42 is provided between the illustrated elastomeric diaphragm and the displacement control portion 30″. For example, movement of the diaphragm toward the displacement control portion 30″ will move the valve rod (upwardly, as viewed in FIG. 2) to open the discharge pressure valve in the upper (as viewed in FIG. 2) portion of the control valve 10″. This is accomplished by increasing pressure on the bottom (as viewed in FIG. 2) of the diaphragm relative to the pressure on the top (as viewed in FIG. 2) of the diaphragm, by operating the microvalve 802 to allow fluid communication between the discharge fluid passageway 804 and the reference fluid passageway 806. With the discharge pressure valve open, crankcase pressure in the compressor will rise, de-stroking the compressor. The pressure on the bottom of the diaphragm can be decreased by operating the microvalve 802 to allow fluid communication between the suction fluid passageway 808 and the reference fluid passageway 806, resulting in the discharge pressure valve closing, the compressor crankcase pressure falling, and the compressor up-stroking. Note that, once a pressure is set on the bottom of the diaphragm by setting the pressure in the reference fluid passageway 806, if the pressure on the top of the diaphragm falls below that set pressure, the diaphragm will be urged to move the valve rod upwardly, opening the discharge pressure valve and increasing crankcase pressure, de-stroking the compressor. Thus, even without a bellows arrangement similar to the bellows 42, the arrangement of FIG. 2 will operate to control compressor loading. The microvalve 802 can be electronically operated as needed to change pressure below the diaphragm to control compressor loading in response to changed air conditioning requirements or to provide freeze protection.

The principle and mode of operation of this invention have been explained and illustrated in its preferred embodiment. However, it must be understood that this invention may be practiced otherwise than as specifically explained and illustrated without departing from its spirit or scope.

What is claimed is:

1. An electromechanical control valve for a variable displacement compressor of the type having a piston having a displacement within a compression chamber, the compression chamber admitting gas from a suction area at a suction pressure and discharging gas to a discharge area at a discharge pressure, the compressor having a crankcase which is filled with a gas at a crankcase pressure, the displacement of the piston varying according to the crankcase pressure, the electromechanical control valve controlling the crankcase pressure, the electromechanical control valve comprising:
a compressor displacement control portion, including:
a discharge pressure valve portion for controlling gas communication between the discharge area and the crankcase chamber; and
a coupling member operatively connected to said discharge valve portion for controlling gas communication between the discharge area and the crankcase chamber;
a variable setpoint control portion including
a reference chamber isolated from the crankcase chamber and containing gas at a reference pressure; and
a microvalve device for controlling at least one of the flow of gas from the discharge area to said reference chamber and the flow of gas from said reference chamber to the suction area in response to signals, thereby establishing said reference pressure; and.
a pressure sensitive component disposed between said compressor displacement control portion and said variable setpoint control portion, said pressure sensitive component having a suction pressure receiving area in communication with gas at the suction area and a reference pressure receiving area in communication with gas in said reference chamber, said pressure sensitive component moving in response to a differential pressure between the reference pressure and the suction pressure.

2. The control valve according to claim 1, wherein said pressure sensitive component includes a flexible diaphragm.

3. The control valve according to claim 2, wherein said pressure sensitive component further includes a rigid member operatively disposed between said diaphragm and said coupling member to transmit movement of said diaphragm in response to a differential pressure between said reference pressure and the suction pressure to said coupling member and thence to said discharge pressure valve portion.

4. The control valve according to claim 2, wherein said pressure sensitive component further includes a sealed bellows arrangement having the suction pressure applied to the exterior of said bellows arrangement, said bellows arrangement being operatively disposed between said diaphragm and said coupling member to transmit movement of said diaphragm in response to a differential pressure between said reference pressure and the suction pressure to said coupling member and thence to said discharge pressure valve portion, and in response to the suction pressure because the length of said bellows arrangement is related to the suction pressure.

5. The control valve according to claim 3, wherein said pressure sensitive component further includes a sealed bellows arrangement with the suction pressure being applied to the exterior of said bellows arrangement, said sealed bellows arrangement being operatively disposed between said rigid member and said coupling member to transmit movement of said diaphragm in response to a differential pressure between said reference pressure and the suction pressure to said coupling member and thence to said discharge pressure valve portion, and in response to the suction pressure because the length of said bellows arrangement is related to the suction pressure.

6. The control valve according to claim 1, wherein said reference chamber is a closed space formed by rigid walls, said reference pressure receiving area of said pressure sensitive member, and a plug upon which the microvalve device is mounted.

7. The control valve according to claim 6, wherein said microvalve device comprises:
a body defining a cavity;
at least two connections providing fluid communication for gas through said body to said cavity, and
a microvalve element disposed in said cavity which is movable relative to at least one of said connections to control the flow of gas through at least one of said at least two connections.

8. The control valve according to claim 7, wherein said plug upon which said microvalve device is mounted comprises a manifold defining at least two fluid passageways in fluid communication with respective ones of said at least two connections of said microvalve device.

9. The control valve according to claim 1, further including a suction pressure valve portion for controlling gas communication between the crankcase chamber and the suction area, said coupling member being operatively connected to said suction valve portion for controlling gas communication between the crankcase chamber and the suction area.

10. A pressure control MEMS device, comprising:
a control valve adapted to be connected to a source of pressurized fluid, and adapted to be connected to a load, said control valve controlling a path of fluid communication between the source of pressurized fluid and the load;
a structure defining a reference chamber;
a microvalve device connected in fluid communication with said reference chamber to establish a reference pressure in said reference chamber; and.
a pressure sensitive component operatively connected to said control valve; said pressure sensitive component having a system pressure receiving area adapted to be connected to a fluid system to receive fluid at a system pressure, and a reference pressure receiving area in communication with fluid in said reference chamber at said reference pressure, said pressure sensitive component moving to operate said control valve in response to a difference in pressure between said system pressure and said reference pressure.

11. The pressure control MEMS device of claim 10, wherein said pressure sensitive component includes a diaphragm exposed on a first side to said reference pressure and on a second side to said system pressure.

12. The pressure control MEMS device of claim 11, further including a valve rod which is operatively connected to said control valve to operate said control valve; and
a rigid member which is in floating contact with said second side of said diaphragm, said rigid member being operatively connected to move said valve rod in response to movement of said diaphragm.

13. The pressure control MEMS device of claim 12, further including a sealed bellows disposed between said rigid member and said valve rod, said bellows being disposed in said system pressure receiving area and changing length in response to changes in said system pressure.

14. The pressure control MEMS device of claim 12, wherein said control valve is a first control valve, said pressure control MEMS device further including a second control valve adapted to be connected to a low pressure area, and adapted to be connected to said load, said second control valve controlling a path of fluid communication between the load and said low pressure area, said valve rod being operatively connected to first control valve and to said second control valve, said valve rod being moved by said rigid member in a first direction to open said first control valve and shut said second control valve to raise pressure at said load, said valve rod moving in a second direction to open said second control valve and shut said first control valve to lower pressure at said load.

15. An electromechanical control valve for a variable displacement compressor of the type including a piston having a displacement within a compression chamber, the compression chamber admitting gas from a suction area at a suction pressure and discharging gas to a discharge area at a discharge pressure, the compressor also having a crankcase filled with gas at a crankcase pressure, the displacement of the piston varying according to the crankcase pressure, the control valve electromechanical controlling the crankcase pressure, the electromechanical control valve comprising:
a compressor displacement control portion, including:
a discharge pressure valve portion for controlling gas communication between the discharge area and the crankcase chamber;
a suction pressure valve portion for controlling gas communication between the crankcase chamber and the suction area; and
a coupling member operatively connected to said discharge valve portion for controlling gas communication between the discharge area and the crankcase chamber and operatively connected to said suction valve portion for controlling gas communication between the crankcase chamber and the suction area in such a manner that as the coupling member is moved to open the discharge valve portion, the coupling member is moved to close the suction valve portion and as the coupling member is moved to close the discharge valve portion, the coupling member is moved to open the suction valve portion; and
a variable setpoint control portion including:
a pressure sensitive component operatively controlling the position of said coupling member in response to a difference between the suction pressure and a reference pressure; and
a microvalve arrangement in fluid connection with the discharge area and the suction area and controlling the application of gas to said pressure sensitive component to establish said reference pressure.
